(19) United States
(12) Patent Application Publication
(10) Pub. No.: US 2026/0104392 A1
(43) Pub. Date: Apr. 16, 2026

(54) Ultrasonic Phased Array Tomography for Mapping and Evaluating Battery Properties

(71) Applicant: THE HONG KONG UNIVERSITY OF SCIENCE AND TECHNOLOGY, Hong Kong (CN)

(72) Inventors: Fan SHI, Hong Kong (CN); Wuke XU, Hong Kong (CN)

(21) Appl. No.: 19/226,586

(22) Filed: Jun. 3, 2025

Related U.S. Application Data
(60) Provisional application No. 63/658,880, filed on Jun. 12, 2024.

(51) Int. Cl. G01N 29/06; H01M 10/0525; H01M 10/42

(52) U.S. Cl. CPC G01N 29/0654; H01M 10/4285; G01N 2291/0231; G01N 2291/0289; G01N 2291/106; H01M 10/0525

(57) ABSTRACT

Analysis of battery cell structure is performed providing a subsurface ultrasonic phased array imaging system. The phase array uses multiple transmitter-receiver pairs to provide phased array tomography of the battery. The phased array imaging system provides mapping and evaluation of properties of the battery cell structure. The system collects ultrasonic signals scattered from internal anomalies to produce detailed cross-sectional images that reveal locations, distributions and physical properties of the anomalies, accommodating both lateral and thickness variations of scanned portions of the battery cell structure to detect, locate and characterize gases and monitor their evolution in a Lithium Ion Battery (LIB), by producing subsurface interior gas images at different cycles.

### RELATED APPLICATION(S)

The present Patent application claims priority to Provisional Patent Application No. 63/658,880, filed 12 Jun. 2024, which is assigned to the assignee hereof and filed by the inventors hereof and which is incorporated by reference herein.

### BACKGROUND

### Technical Field

The present disclosure relates to ultrasonic imaging utilizing phased array tomography. More particularly, the disclosure relates to using the phased array tomography for mapping and evaluation of properties within various battery types for detecting internal anomalies.

### Background Art

Lithium-ion batteries (LIBs) have been widely used in daily electronic and industrial applications, such as electric vehicles (EVs), smartphones, laptops, etc., and they are under rapid development in recent decades. Thanks to the high energy density, low self-discharge and ever-decreasing cost, LIBs play a key role in sustainable energy generation and storage for achieving carbon neutrality. The high voltage necessary for the high energy density in LIBs can trigger a range of failure mechanisms particularly if defects appear from battery manufacturing and material aging. As one of the primary failure mechanisms, gassing caused by electrolyte and electrode decompositions can significantly degrade battery performance and lifespan. This presents battery safety concern attributed to the highly flammable gas products generated during chemical side reactions. Additionally, gas evolution can also lead to electrode degradation, diminished cycle and shelf life, electrolyte displacement, and weakened mechanical properties due to uneven pressure. Gases are highly unstable in their evolution and therefore in-situ and non-invasive diagnostic methods are required to detect and monitor gases, in order to understand their dynamic properties, give early safety warnings, and assist the design of new battery materials with longer lifetime and improved safety.

A number of studies have been carried out to investigate the gas evolution of LIBs. In general, non-invasive gassing detection methods can be divided into three categories:
1) Visual Testing—Large quantities of gases can lead to visible battery cell swelling, which indicates that gassing is in a very late stage. The charging/discharging process and temperature variation can also cause thickness changes, and it is difficult to distinguish the small amount of gas generation mixed by these factors.
2) Online Mass Spectroscopy—Differential electrochemical mass spectrometry (DEMS) monitors the potential and current of a LIB and detects gases if signal anomalies are observed. The gas constituents can be identified for gassing mechanism analysis. Nevertheless, only volatile products can be detected by this method, which may compromise the sensitivity of gas detection and it does not allow for direct localization and imaging of gases.
3) X-ray Tomographic Imaging—X-ray tomography enables a three-dimensional reconstruction of battery structures with a high resolution. X-ray tomography has been used to capture the spatial distribution of gas channels inside the LIB cell, and the cell deformation led by gas agglomeration was observed. In practice, gases are detected in an X-ray image through observation of layer structure and a change of grayscale pixel values, and hence, to a great extent, the sensitivity depends on the imaging contrast.
4) Neutron Radiography—In-situ neutron imaging has been applied in a few studies for instance to track the distribution of lithium and hydrogen to correlate gas evolution during cell operation.

Acoustic or ultrasonic methods for inspecting LIBs have attracted increasing attention because of their advantages of being low-cost, efficient, and highly sensitive to material changes. Hsieh et al., “Electrochemical-acoustic time of flight: in operando correlation of physical dynamics with battery charge and health”, Environmental Science 9 (2015), demonstrated the feasibility of using acoustic signals to monitor the dynamic physical properties of LIBs during cycling. The changes in time-of-flight (ToF) and amplitudes of signals are correlated with different State of Charge (SoC) levels. In addition to the SoC measurement, Bommier et al., “In Operando Acoustic Detection of Lithium Metal Plating in Commercial LiCoO₂/Graphite Pouch Cells”, Cell Reports Physical Science 1, 100035 (2020), used the acoustic ToF change to indicate the lithium metal plating in commercial pouch cells during operation. Robinson et al., “Identifying Defects in Li-Ion Cells Using Ultrasound Acoustic Measurements”, J. Electrochem. Soc. 167, 120530 (2020), performed the acoustic ToF analysis to detect the designed electrode defects. Deng et al., “Ultrasonic Scanning to Observe Wetting and ‘Unwetting’ in Li-Ion Pouch Cells”, Joule 4, 2017-2029 (2020), used the ultrasonic scanning method for the detection of electrolyte unwetting and gassing according to the reduction of transmission amplitude.

In general, battery analysis has focused on analysing signals transmitted through the battery or obtaining an in-plane ultrasonic image (i.e., battery surface plane) by scanning the battery, which represents averaged through-thickness physical properties. It is difficult to locate the material anomalies (e.g., gases) in the depth direction and obtain the fine characteristics (e.g., lateral size) of gases due to limited resolution and sensitivity. In addition, most studies utilize a single ultrasonic transducer to measure pulse-echo signals in the normal direction, which is time-consuming when scanning the whole battery. The oblique incidence wave which contains rich information about the battery structure and defects is not used in practice. As an alternative, ultrasonic phased arrays with multiple electronic elements have been used in medical imaging and industrial non-destructive evaluation (NDE) applications with a high flexibility of sending, receiving and focusing waves at different angles. By electronically controlling multiple transmitter-receiver pairs, it is possible to render a subsurface cross-section image showing material defects and anomalies with high resolution, and the location and characteristics of defects can be quantified. Compared with mechanical scanning with a single probe, array imaging is usually much more efficient and can achieve a higher detection sensitivity because signals from multiple sensors are used, leading to an improved signal-to-noise ratio (SNR).

### SUMMARY

Analysis of battery cell structure is performed with a subsurface ultrasonic phased array imaging system, using multiple transmitter receiver pairs to provide phased array tomography. Mapping and evaluating properties of the battery cell structure is performed. The mapping is used to detect, locate and characterize gases and monitor evolution of the gases in the battery cell structure, by producing subsurface interior gas images at different cycles. The ultrasonic phased array imaging system is able to collect ultrasonic signals scattered from internal anomalies to produce cross-sectional images that reveal locations, distributions and physical properties of the anomalies, accommodating both lateral and thickness variations of scanned portions of the battery cell structure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A and 1B are schematic diagrams showing imaging techniques.

FIG. 1A shows TFM imaging using a phase array probe. FIG. 1B shows imaging using back surface reflection from a phased array transmission.

FIGS. 2A-2D are a diagram (FIG. 2A) and SEM images (FIGS. 2B-2D) of the array measurement from a multi-layer battery cell. FIG. 2A is a diagram showing a finite element model for simulating array measurement from a multi-layer battery cell. FIGS. 2B-2D are SEM images for the battery's electrodes. FIG. 2B is a SEM image of the cathode (×1000). FIG. 2C is a SEM image of the anode (×1000). FIG. 2D is a SEM image showing PVDF bonding (×45000).

FIGS. 3A-3L are TFM images of gas bubbles in Lithium-ion batteries (LIB) from finite element simulations. FIGS. 3A, 3B and 3C are finite element models containing gas bubbles with different sizes, with FIG. 3A showing 1 mm×0.2 mm, FIG. 3B showing 0.5 mm×0.1 mm, FIG. 3C showing two 0.5 mm×0.1 mm bubbles. FIGS. 3D, 3E and 3F are corresponding TFM images showing gas bubble generation, with FIGS. 3D and 3E showing 1 MHz, FIGS. 3G, 3H and 3I showing 2 MHz; and FIGS. 3J, 3K and 3L showing 5 MHz.

FIG. 4 is a schematic diagram showing an experiment configuration of in-situ TFM array imaging of battery gas evolution.

FIGS. 5A-5D show a controlled experiment with encapsulated gas using an LFP battery sample with air-filled microcapsules. FIG. 5A shows stacked electrodes with microcapsules used in the battery sample, presenting perspectives in size identified in the segments (a) (d-), FIG. 5B is a graphic representing velocity-angle profiles. FIG. 5C is a TFM image of the microcapsule incorporated LIB using a velocity-modified method. FIG. 5D is a TFM image of the microcapsule incorporated LIB using a traditional method.

FIGS. 6A-6C show a battery cycling experiment. FIG. 6A shows the experiment configuration. FIG. 6B is a graphic representation showing battery capacity and efficiency versus cycle number. FIG. 6C is a graphic representation showing voltage versus capacity in specific cycles corresponding to the subsequent TFM images.

FIGS. 7A-7M show the results of TFM imaging. FIG. 7A shows the sequence of cycles. FIGS. 7B-7D, 7F-7H and 7J-7L are TFM images of gases at different cycling stages. FIGS. 7E, 7I and 7M are post-processed TFM images at typical cycles after applying a −6 dB threshold, corresponding to respective image groups of FIGS. 7B-7D, 7F-7H and 7J-7L.

FIGS. 8A-8F show X-ray tomography verification. FIGS. 8A-8C are X-ray computer tomography (CT) images of a battery in an initial state in top, front and right views. FIGS. 8D-8F are X-ray CT images of a battery in an after cycling state (i.e., after cycling) in top, front and right views.

### DETAILED DESCRIPTION

### Overview

The present disclosure introduces an advanced subsurface ultrasonic phased array imaging system designed for the comprehensive analysis of battery cell structures. The system employs multiple transmitter-receiver pairs to facilitate phased array tomography, enabling detailed mapping and evaluation of various properties within the battery. By collecting ultrasonic signals that are scattered from internal anomalies, the system generates high-resolution 2D or 3D images that accurately reveal the locations, distributions, and physical characteristics of these anomalies. This capability accommodates both lateral and thickness variations in the scanned portions of the battery cell structure. Furthermore, the system is specifically adept at detecting, locating, and characterizing gases within Lithium-Ion Batteries, as well as monitoring their evolution throughout different operational cycles. This innovative approach enhances the understanding of battery behavior, particularly concerning internal defects and gas generation, ultimately contributing to improved safety and performance in battery technology.

Terms used in the example embodiments are selected from currently widely used general terms when possible while considering the functions in the present disclosure. The terms may vary depending on the intention or precedent of a person skilled in the art, the emergence of new technology, and the like. Further, in certain cases, there are also terms arbitrarily selected by the applicant, and in the cases, the meaning will be described in detail in the corresponding descriptions. Therefore, the terms used in the present disclosure should be defined based on the meaning of the terms and the contents of the present disclosure, rather than the simple names of the terms. Throughout the specification, when a part is described as “comprising or including” a component, it does not exclude another component but may further include another component unless otherwise stated.

An advanced in-situ subsurface ultrasonic array imaging system and method utilizing phased array tomography is used for comprehensive mapping and evaluation of properties within various battery types. Multiple ultrasonic phased array transmitter-receiver pairs are employed to collect ultrasonic signals scattered from internal anomalies. The tomography imaging technique is then utilized to produce detailed cross-sectional images that reveal the locations, distributions and physical properties of these anomalies, accommodating both lateral and thickness variations.

The ultrasonic phased array imaging technique is exploited to detect, locate and characterize gases and monitor their evolution in a Lithium Ion Battery (LIB), by producing subsurface interior gas images at different cycles. Gassing mentioned in this work includes gas production caused by chemical factors such as the electrolyte decomposition and solid electrolyte interface (SEI) rupture, and that caused by physical factors such as the electrolyte dry-out due to the electrode expansion and deformation. The ultrasonic array imaging methodology includes Full Matrix Capture (FMC) data collection and Total Focusing Method (TFM) for gas imaging. A modified TFM considering the anisotropic variation of the wave velocity in a layered battery structure is applied. The numerical simulation results show the accuracy of the imaging method at different frequencies using the velocity-modified TFM technique. The experiment setup and results are used to evaluate the performance of the ultrasonic array imaging on gas evolution in LIBs.

While one LIB is described, it is expected that the disclosed techniques will also be useful in the analysis of stacked LIB battery cells and stacked LIBs.

### Formulation of Imaging

Full Matrix Capture (FMC) is a phased array data acquisition technique which collects the complete set of data from all the combinations of transmitter-receiver pairs. One single array element transmits signals while all the elements work as the receivers. The process repeats until all the elements are fired. A phased array containing n elements captures a matrix with n² A-scan signals, known as the full matrix of data. FMC offers the maximum possible information for imaging the interior structure of a battery. In addition, the data collection from FMC is sufficiently fast due to the electronic control of array elements.

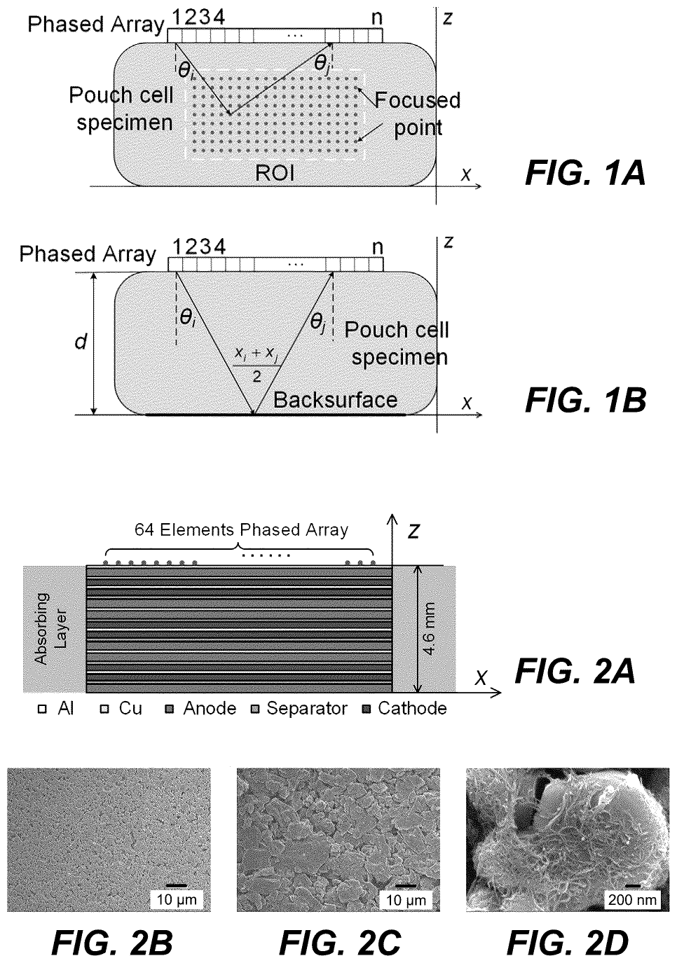

FIGS. 1A and 1B are schematic diagrams showing imaging techniques. FIG. 1A shows TFM imaging using a phase array probe. FIG. 1B shows imaging using back surface reflection from a phased array transmission.

With the full matrix of data, it is possible to then apply TFM to generate a cross-section subsurface image (e.g., x-z plane image) as shown in FIG. 1A. TFM has been widely used in the field of NDE for detecting and characterising tiny defects in various materials. The region of interest (ROI) for imaging is discretized into a grid and the received ultrasonic signals are summed after applying proper time delays to focus at every image grid point. The intensity of the image pixel, I, at any point (x, z) is given by:

$$I ( x , z ) = \vert {\sum }_{i = 1}^{n} {\sum }_{j = 1}^{n} {h}_{ij} ( {t}_{ij} ( x , z ) ) \vert \qquad ( 1 )$$

where i and j are the indices of transmitting and receiving array elements, h is the analytic signal converted by the Hilbert transform, and t represents the time delay which is given by:

$${t}_{ij} ( x , z ) = \frac{\sqrt{{( {x}_{i} - x )}^{2} + {( {z}_{i} - z )}^{2}} + \sqrt{{( x - {x}_{j} )}^{2} + {( z - {z}_{j} )}^{2}}}{c} \qquad ( 2 )$$

where (xᵢ, zᵢ):(xⱼ, zⱼ) are the coordinates of the transmitter and the receiver respectively, c is the ultrasonic longitudinal wave velocity.
Imaging with Anisotropic Velocity Correction

A LIB is manufactured by stacking multiple layers including cathodes, anodes, separators and current collectors as a multi-layer structure. The layered structure has a significant influence on the propagation of ultrasonic waves at different angles. The mismatch in the acoustic impedance between different layers will induce refraction and reflection when the ultrasonic wave passes through the interface, which causes the medium to exhibit a certain extent of anisotropy. When the material heterogeneity (e.g., layer thickness) is much smaller than the wavelength, layer reflections are small and the multi-layer battery can be homogenized effectively as a transversely isotropic medium. The wave velocity depends on the propagation angle in the x-z plane. Erroneous image results may occur if the velocity term in Eq. (2) is not corrected. Additionally, the electrode material itself also has anisotropic properties due to the inhomogeneity of micro-particles and the pressing step during the manufacturing process. Hence, the TFM imaging algorithm needs to be modified for the mechanical anisotropy inside the battery.

In this non-limiting example, a pragmatic approach is adopted to directly measure the ultrasonic group velocity as a function of angle. This technique was originally developed in inspecting voids inside thick composite structures. Under the long-wavelength assumption that waves see the whole battery as a homogeneous medium, signals reflected from the battery back surface are utilized to determine the angular velocity profile. As illustrated in FIG. 1B, for a transmitter element i and a receiver element j, the ultrasonic waves are reflected following the specular direction from the back surface. In this case, the propagation angle of both the transmission and reflection waves with respect to the z direction is given by:

$${θ}_{i} = {θ}_{j} = tan ( \vert \frac{{x}_{i} - {x}_{j}}{2 d} \vert ) \qquad ( 3 )$$

where d is the thickness of the battery cell. If the propagation time of the ultrasonic wave can be determined accurately, the velocity at a specific angle can be calculated as:

$${c}_{ij} = \frac{\sqrt{{( {x}_{i} - {x}_{j} )}^{2} + 4 {d}^{2}}}{{t}_{ij}} \qquad ( 4 )$$

In this manner, the scattering signals from gases at different angles will be coherently focused, showing correct features and locations of gases in the cross-section image.

### Numerical Simulation Using a Finite Element Model

FIGS. 2A-2-D are a diagram (FIG. 2A) and SEM images (FIGS. 2B-2D) of the array measurement from a multi-layer battery cell. FIG. 2A is a diagram showing a finite element model for simulating array measurement from a multi-layer battery cell. FIGS. 2B-2D are SEM images for the battery's electrodes. FIG. 2B is a SEM image of the cathode (×1000). FIG. 2C is a SEM image of the anode (×1000). FIG. 2D is a SEM image showing PVDF bonding (×45000).

Before conducting experiments, two-dimensional finite element simulations are run to evaluate the performance of the proposed array imaging technique for gases, using the software Pogo. First, FMC of signals in an intact battery model are simulated and the back surface reflection signals are used to determine the velocity-angle profile. Then gases of diverse dimensions are introduced into the finite element model and simulate the scattering signals received by the array elements. The lateral scale of gases in the simulations is comparable to or smaller than the ultrasonic wavelength and the geometrical scattering effects dominate, so an acoustic pressure-free boundary condition is used to model gases. In all the simulations, the incident wave is a three-cycle Hann-windowed tone burst signal. The centre frequencies are set to be 1 MHz, 2 MHz, and 5 MHz respectively to investigate the effects of frequency on imaging. The finite element model is meshed with linear rectangular elements with a size of 5 μm, around 1% of the ultrasonic wavelength and the convergence is ensured. The time step is set based on the Courant criterion. The whole finite element model is a rectangular region with a thickness of 4.6 mm as shown in FIG. 2A. The battery model follows the layer structures and electrode parameters described in Table 1, which are obtained from a commercial LIB sample (Lifun 575166, produced by Lifun Technology, Zhuzhou, Hunan, China). Absorbing layers are applied to eliminate unwanted boundary reflections from the two sides. A phased array composed of 64 array elements is modelled on the top of the battery with the element spacing of 0.5 mm, 0.25 mm, and 0.1 mm, for 1 MHz, 2 MHz, and 5 MHz, respectively. Each element acts as both the transmitter and receiver to get the full matrix of data. After data collection, the velocity-modified TFM described in Eq. (6) is applied to reconstruct images of gas bubbles in the battery, from which the locations, sizes and population of gas bubbles can be obtained.

The mechanical properties of electrodes and separators need to be determined for building the battery finite element model. As shown in FIGS. 2B and 2C, the cathode and anode each have a complex microstructure resulting from the electrode manufacturing process. The particles in the electrode are bonded by the polymer binder, shown in FIG. 2D, which does not provide a strong force.

Table 1 shows the material parameters of the individual layers in the example LIB. The mechanical properties of each layer in the battery are obtained from a disassembled commercial LIB as detailed in the table, where d represents the thickness of each layer. The values are calculated according to the press density provided by the battery manufacturer. The bulk modulus and density of electrolyte are 1 GPa and 1320 kg/m³.

TABLE 1
Material parameters of the individual layer in the LIB.

| Layers | | Cathode | Anode | Cu | Al | Separator |
|---|---|---|---|---|---|---|
| Particle | K (GPa) | 125 | 28.8 | | | |
| Properties | ρ (kg/m³) | 4789 | 2070 | | | |
| | ν | 0.28^{Λ} | 0.275^{Λ} | | | |
| Structure | K (GPa) | 3.5 | 3.33 | 117 | 69 | 1.5 |
| Properties | G (GPa) | 1 | 1 | 44.7 | 25.5 | 0.73 |
| | ρ (kg/m³) | 3667 | 1850 | 8940 | 2700 | 1550 |
| Layer | d (μm) | 60 | 70 | 10 | 10 | 20 |
| Properties | | | | | | |

Here we use the rule of mixture to estimate the mechanical properties of electrodes. The mechanical properties of electrodes can be calculated as:

$$\frac{1}{K} = \frac{1 - v}{{K}_{s}} + \frac{v}{{K}_{l}} , ρ = v {ρ}_{l} + ( 1 - v ) {ρ}_{s} , G = {G}_{PVDF} \qquad ( 7 )$$

where K, Kₛ, Kₗ represent the bulk modulus of the saturated porous electrode, solid particle and electrolyte respectively;
ρ, ρₛ, ρᵢ represent the density of the saturated porous electrode, solid particle and electrolyte respectively;
v is the porosity of electrodes.

In addition, since electrode particles are bonded by PVDF as shown in FIG. 2D, the shear modulus of the electrode is mainly contributed from that of PVDF. The mechanical properties of the separator are estimated by Biot's theory because the microstructure of separator shows that it is a continuous porous medium filled with liquid electrolyte.

To measure the velocity profile, an intact battery finite element model is first built without any gas, and the simulation is run to obtain the FMC data using a phased array. The velocity profile is then calculated according to the wavepaths and the time-of-flight data at different angles, as the basis for performing the velocity-modified TFM imaging of gases.

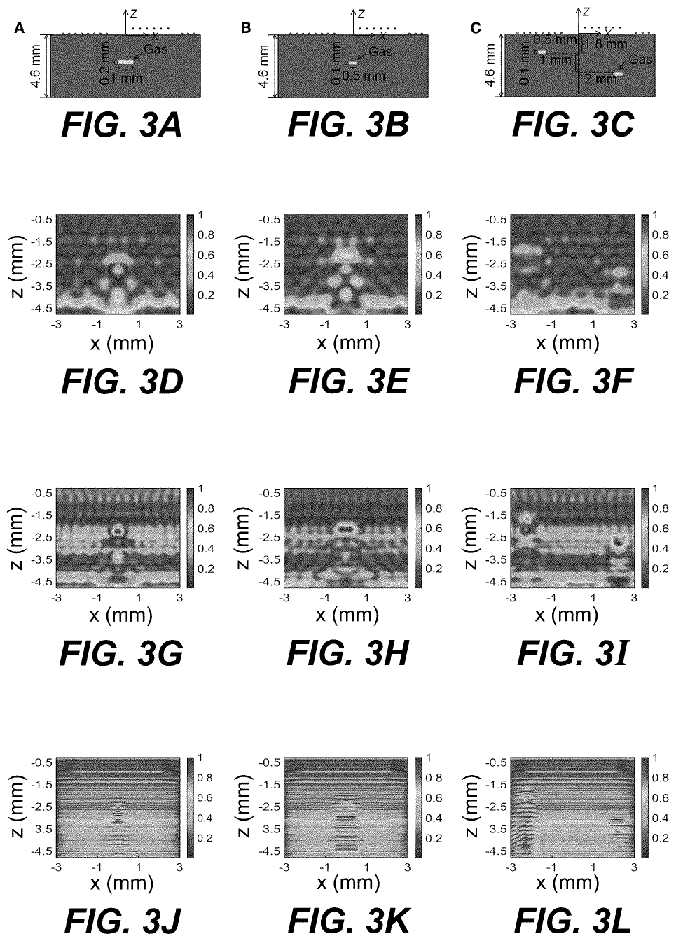

FIGS. 3A-3L are TFM images of gas bubbles in a LIB from finite element simulations. FIGS. 3A, 3B and 3C are finite element models containing gas bubbles with different sizes, with FIG. 3A showing 1 mm×0.2 mm, FIG. 3B showing 0.5 mm×0.1 mm, FIG. 3C showing two 0.5 mm×0.1 mm bubbles. FIGS. 3D, 3E and 3F are corresponding TFM images showing gas bubble generation, with FIGS. 3D and 3E showing 1 MHz, and FIGS. 3G, 3H and 3/showing 2 MHz; and FIGS. 3J, 3K and 3L showing 5 MHz.

Gas bubbles can have dimensions ranging from micrometre to sub-millimetre and millimetre scales. In the disclosed simulations, the gases are set at sub-millimetre scales and the geometrical scattering effects dominate. Three simulation cases are shown, including one gas with a dimension of 1 mm×0.2 mm in the middle of the battery model in FIG. 3A, and FIGS. 3B and 3C containing gas bubbles with a dimension of 0.5 mm×0.1 mm, similar with those found in X-ray CT studies. The imaging results for different gases when the frequencies are 1 MHz, 2 MHz and 5 MHz are shown in FIGS. 3D-3L. The imaging resolution and defect detection sensitivity increase when the frequency is higher, while the noise becomes larger. The noise is mainly caused by layer reflected waves, which are coherently added as image artifacts. It is useful to investigate the effects of different frequencies on the overall image quality, which helps choose feasible frequency ranges for imaging. FIGS. 3D-3F show the imaging results using a 1 MHz phased array, and the ultrasonic wavelength is calculated to be around 1.3 mm. The battery back surface and the gases are clearly visualized indicated by bright spots with large pixel values in FIGS. 3D-3F. For a 2 MHz phased array, the wavelength is reduced to around 0.65 mm and gases with different sizes and locations can be visualized in FIGS. 3G-3I, with improved image resolution. In the middle of the cell, some artifacts caused by layer reflections can be observed. The two spatially separated gas bubbles are clearly detected in FIG. 3I and the lateral size of the gases can be estimated from images as well. In practice, due to the vertical pressure within layers, the gases tend to have strip/channel-like shapes; hence the lateral dimension is an important feature for characterising gases. As the frequency continues increasing to 5 MHz, the imaging results with higher resolution are shown in FIGS. 3J-3L, giving clearer shapes of the gases. Although gas bubbles can be indicated by bright spots in the images, the artifacts caused by strong layer reflections can become much more severe. The positions of battery layers can be roughly identified from the image. This phenomenon may be caused by the ultrasonic resonance between multiple battery layers at 5 MHz, which is explained in Huang, M. et al., “Quantitative characterisation of the layered structure within lithium-ion batteries using ultrasonic resonance”, Journal of Energy Storage 50, 104585 (2022). Simulations demonstrate that the position and depth of gases can be identified from TFM images if choosing a proper ultrasonic frequency and array aperture.

### Experimental Results

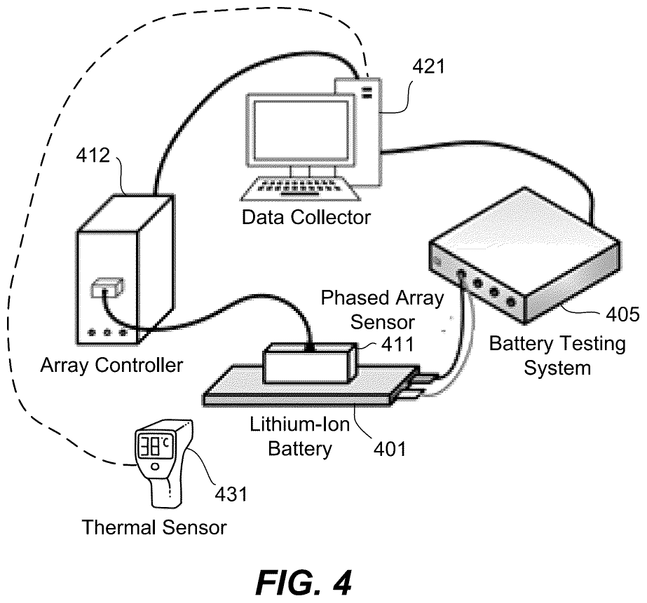

FIG. 4 is a schematic diagram showing an experiment configuration of in-situ TFM array imaging of battery gas evolution. Depicted is LIB 401 as a unit under test, driven by battery testing system 405, phased array sensor 411 and array controller 412, and data collector 421. A thermal sensor 431 is also shown. The battery testing system is capable of charging and discharging LIB 401 in order to cycle LIB 401 to perform the analysis. Thermal sensor 431 may be used to monitor battery temperature and changes in battery temperature during cycling, although this was not integrated into the initial test configuration.

In addition to the numerical simulations, two experiments are performed to further show the capability of the TFM imaging of gases and their evolution in LIBs. Two samples are prepared to serve different experimental purposes: (1) A manually stacked LFP/graphite pouch cell incorporating poly urea-formaldehyde (PUF) hollow air-filled microcapsules to physically mimic gas bubbles in the battery medium for the controlled experiment; and (2) A commercial LCO/graphite “jelly roll” pouch cell to conduct the gas evolution experiment during the charging/discharging cycles. In the second experiment, the commercial LIB sample is charged and discharged through multiple cycles controlled by an 8-channel battery testing system (LANHE, CT3002K). A 64-channel linear ultrasonic phased array probe (Doppler Co. Ltd.) with a centre frequency of 1 MHz is placed on the top surface of the LIB with couplant gel.

The frequency is chosen to achieve a balance between the detection/imaging resolution and layer induced noise.

TABLE 2
Parameters of the ultrasonic phased array used in experiments.

| Centre | Number of | Element | Element | Element |
|---|---|---|---|---|
| Frequency | elements | interspace | pitch | elevation |
| 1 MHz | 64 | 0.15 mm | 0.75 mm | 10 mm |

Parameters of the phased array probe are given in Table 2. All the array elements are used for transmitting and receiving ultrasonic waves, and the signals from the FMC are recorded by a 64-channel commercial array controller (Verasonics Vantage NXT 64™, manufactured by Verasonics, Kirkland WA, USA) for post-processing.

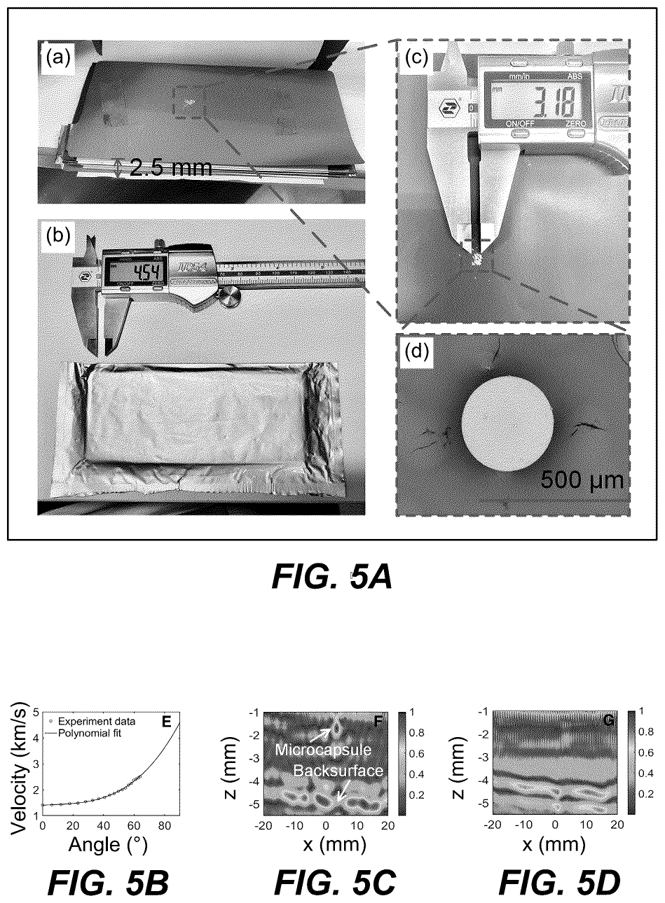

FIGS. 5A-5D show a controlled experiment with encapsulated gas using an LFP battery sample with airfilled microcapsules. FIG. 5A shows a battery microcapsule used in the battery sample, presenting perspectives in size identified in the segments (a) (d), FIG. 5B is a graphic representing velocity-angle profiles. FIG. 5C is a TFM image of the microcapsule incorporated LIB using a velocity-modified method. FIG. 5D is a TFM image of the microcapsule incorporated LIB using a traditional method.

In FIG. 5A, segment (a) shows stacked electrodes with microcapsules used in the battery sample. Segment (b) of FIG. 5A shows a pouch cell from the battery sample with a thickness of 4.54 mm. Segment (c) of FIG. 5A shows a cluster of microcapsules with a dimension of 3.18 mm. Segment (d) of FIG. 5A is a SEM image for one typical microcapsule. FIG. 5B is a graphic representing velocity-angle profiles. FIG. 5C is a TFM image of the microcapsule incorporated LIB using a velocity-modified method. FIG. 5D is a TFM image of the microcapsule incorporated LIB using a traditional method.

In the controlled experiment, the pouch cell is assembled by stacking multiple commercial LFP/graphite electrodes with a total thickness of 4.54 mm. A cluster of PUF hollow microcapsules filled with air is incorporated into the pouch cell at the electrode layer as shown in segment (a) of FIG. 5A, with a distance of 2.5 mm away from the bottom surface during battery assembling. These hollow microcapsules have a mean diameter of about 300 μm as illustrated in segment (d) of FIG. 5A. They are manufactured by one layer of PUF with a thickness of about 300 nm. The Young's modulus of PUF is about 3.5 GPa, which is not much different from the surrounding saturated electrode (3.33 GPa). Hence, the reflection is mainly determined by the encapsulated air. The battery sample is not charged or discharged during the ultrasonic measurement, because the purpose of the controlled experiment is to evaluate the imaging performance in a real battery mechanical structure with pre-made gas defects.

The wave velocity values are first measured at different angles using the array probe and the angle-velocity profile, as represented in FIG. 5B. The wave velocity at 60° is around 2700 m/s, with an increase of around 85% compared with that at 0° (1450 m/s in the normal direction), demonstrating a strong mechanical anisotropy within the x-z plane. Then the phased array is placed above the region with microcapsules to perform the FMC measurement of reflection signals. The phased array probe is placed at z=3 mm in the image coordinate and thus the back surface is in the position of about z=−1.54 mm. Two gas images produced by the modified TFM and the traditional TFM are shown in FIGS. 5C and D. The cluster of microcapsules can be clearly identified from the bright pixel values in FIG. 5C (velocity-modified method), and they are in the correct location as originally deployed in the battery. In addition, it is possible to also observe the correct location of the battery back surface and there is a slight reduction of back surface signals below the microcapsules. In contrast, the microcapsules are almost invisible in the image produced by the traditional TFM without angular correction of velocity values. The pixels referring to the back surface are also weak. The lateral size of the microcapsule cluster in FIG. 5C can be approximately estimated as 2.95 mm by observing the pixel values, which is slightly smaller than the actual measured value of 3.18 mm. The small error could be resulted from the fact that some microcapsules at the edge of the cluster are moved away during the electrolyte injection or vacuuming operation after the assembly of the pouch cell. The results of the controlled experiment show the strong feasibility of using the modified TFM for imaging gases and the evolution in a multi-layer battery medium.

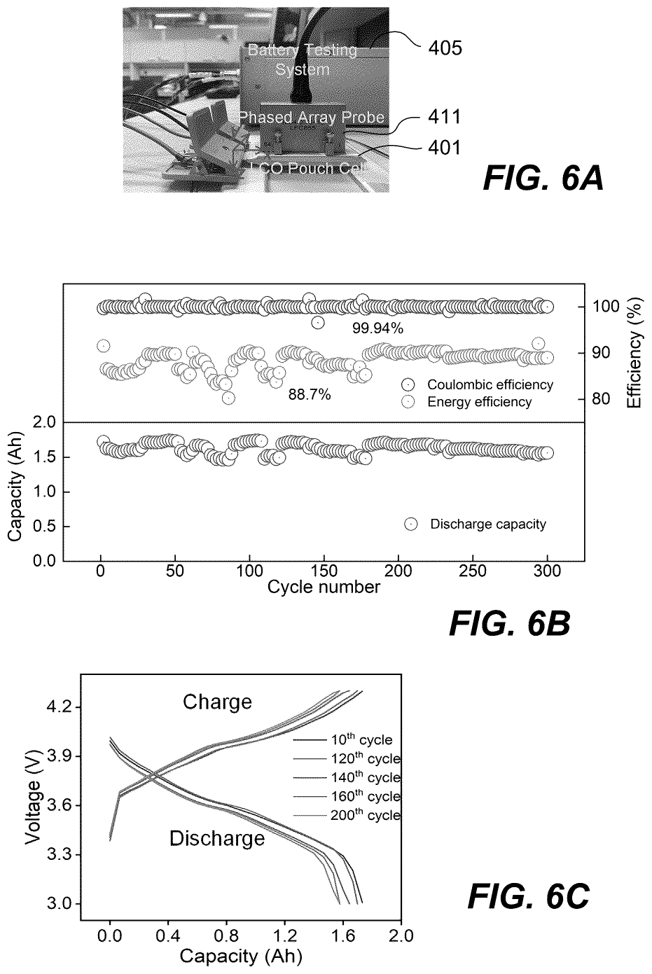

FIGS. 6A-6C show a battery cycling experiment. FIG. 6A shows the experiment configuration. FIG. 6B is a graphic representation showing battery capacity and efficiency versus cycle number. FIG. 6C is a graphic representation showing voltage versus capacity in specific cycles corresponding to the subsequent TFM images.

A commercial LCO/graphite LIB with a thickness of 8.5 mm is cycled at a constant current of 4 A, to cycle the LIB at 2 C-rate, in the nominal voltage range from 3.0 V to 4.3V using the battery testing system as shown in FIG. 6A. Correlated fluctuations in both the Coulombic efficiency, energy efficiency and battery capacity are observed, as shown in FIG. 6B. The average value of Coulombic efficiency is 99.94% and the capacity decay is less than 15%, with energy efficiency remaining around 89%, all acceptable as a typical performance. They are also consistent with previous studies on the capacity fade of LCO/graphite batteries cycled at high discharge rates, where the capacity of the tested battery decreased by 13.6% after 300 cycles at a 2 C-rate. The capacity decay was attributed to the decomposition of the electrolyte and chemical side reactions, which may cause the formation of a thicker solid electrolyte interface (SEI) layer and gas generation. The Coulombic efficiency of the LIB cycling experiment is high but still measurably lower than unity. We thus expect gas bubbles to evolve over the course of 300 cycles, even if only a fraction of the lost charge goes to generate gas.

FIG. 6C shows the voltage vs. capacity curves resulting from cycling. FIG. 6C shows the corresponding ultrasonic TFM images at the same cycles in the next section for comparison. No obvious abnormalities in the capacity curves can be observed. It is noted that, as indicated from the experimental data, it is difficult to identify any state of gas evolution in the battery with confidence. Neither the capacity fade nor the efficiency fluctuation could be exclusively linked to gas. There has been research about applying electrochemical impedance spectroscopy (EIS) and model-based estimation as a general non-destructive technology to obtain insights about the state of health/safety of LIBs; however, the EIS results are comprehensive outcomes of multiple factors. The interpretation and analysis of EIS results require sufficient knowledge about properties of the battery components and physical processes during battery operations, which increases the difficulty and ambiguity involuntarily. Also, the accuracy of EIS highly depends on the measurement preconditions and model, which leads to a complex computation and non-uniformity. It is noted that the proposed ultrasonic array imaging technique provides a powerful complement to the traditional gas detection techniques. It can detect and locate gas bubbles from images with a high sensitivity using a simple in-situ measurement setup.

TFM images can be used to provide information regarding gases generated at different charge cycles. The FMC of ultrasonic data is performed every 30 cycles until the battery is cycled 90 times. After the 90th cycle, the frequency of measurements is increased to once every 10 cycles. During each measurement, the coupling agent will be reapplied between the probe and the battery under test to ensure good contact. The position of the probe placed on the battery is also fixed by pre-made marks, no additional heavy objects are placed on the probe, and the consistency of the measurement is ensured by its own weight. All of the ultrasonic data are measured with the State of Charge (SoC) level at 100% (i.e., the battery is completely charged). This is to avoid SoC induced material variation and the effects on wave imaging results. It is anticipated that the material variation can be included, so that the imaging can be performed at different SoC levels as well. The length of the phased array probe is 47.25 mm and the TFM imaging area is from −20 mm to +20 mm in the lateral direction (i.e., x axis) and −5 mm to +5 mm in the depth direction (i.e., z axis). The array probe is placed at z=5 mm, to cover as wide an imaging area as possible. In practice, only signals collected by elements numbered from k−20 to k+20 (20<k<44) are used for imaging gases corresponding to a reduced viewing angle within 60°, while k is the index of the incident element. This is because at very large angles, layer reflection induced noise increases rapidly, leading to vague gas features in the image. We find that in the experiment an array aperture angle within 60° can produce images with a reasonably high SNR. The ultrasonic images are post-processed to further quantify the gases and their evolution process. The pixel values are converted into the dB scale and a threshold of −6 dB with respect to the maximum value is applied, below which the pixel values are set as zero. The −6 dB threshold technique is widely used in ultrasonic imaging of defects and voids to remove noise and characterise reflectors.

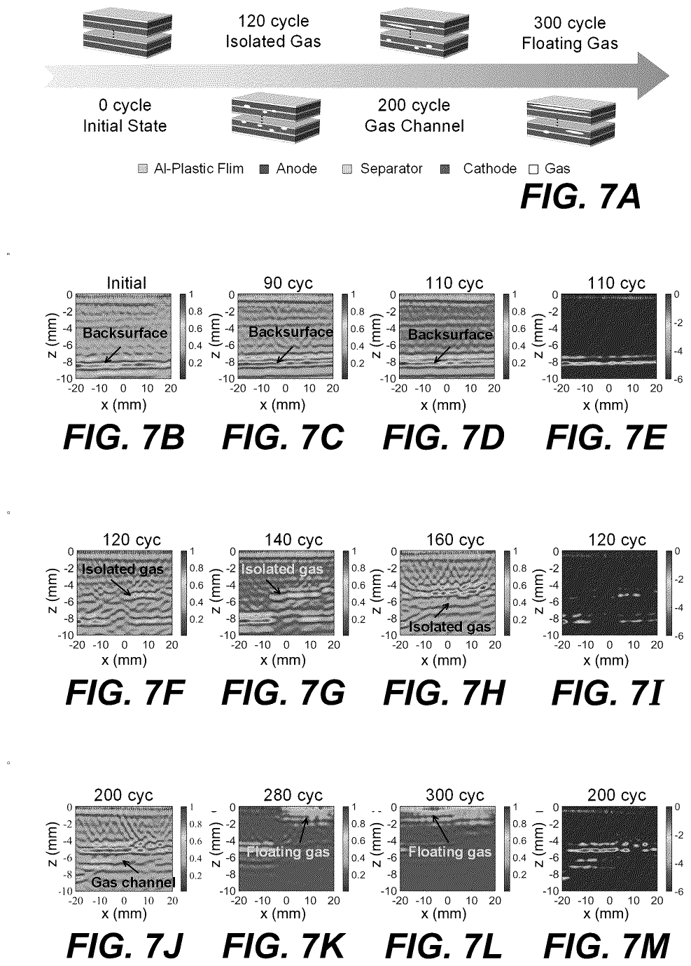

FIGS. 7A-7L show the results of TFM imaging. FIGS. 7A-7C, 7E-7G and 7I-7K are TFM images of gases at different cycling stages. FIGS. 7D, 7H and 7L are post-processed TFM images at typical cycles after applying a −6 dB threshold, corresponding to respective image groups of FIGS. 7A-7C, 7E-7G and 7I-7K.

The results shown in FIGS. 7B-7M show the array imaging results during 300 charging/discharging cycles of the LIB. Within the first 110 cycles, as shown in FIGS. 7B-7D, the back surface features are strong and uniform at the depth of −3.5 mm, corresponding to the correct back surface location. The array is placed at z=5 mm and the total thickness of the battery is 8.5 mm. The image noise in FIGS. 7B-7D is from layer reflections. FIG. 7E shows that after applying the −6 dB amplitude threshold, no clear reflectors can be observed except the strong battery back surface features. This indicates that within the 110th cycle no noticeable gases are generated inside the battery.

In the 120th cycle, as shown in FIG. 7F, several strong reflectors appear inside the battery indicating the appearance of gases, and part of the back surface features becomes much weaker and almost invisible. This is because the gas bubbles largely reflect the probing waves, and the back surface is shadowed as waves are highly scattered and attenuated by the gas bubbles. Due to the pressure of the gases, the flat layer structure inside the battery is also somewhat distorted, which is demonstrated in the image as the image pixels referring to layer reflection become bent. FIG. 7I shows several separated reflectors representing isolated gases after applying the −6 dB threshold, and the back surface reflection becomes very weak at the 120th cycle. The images show that the gases start to generate inside the battery between the 110th and 120th cycle. The locations, distributions and sizes of the gas bubbles can be roughly identified from the image, and most of gas bubbles are located in the depth near z=−1 mm to z=1 mm.

As the battery cycling progresses, the amount of gas bubbles gradually increases, and they aggregate and expand as stronger reflectors can be identified from FIGS. 7G and 7H between the 120th cycle and the 160th cycle. Additionally, most of the gases are observed around the middle of the cell, and the reason will be explained below. As more gases are generated, the back surface signal is further blocked. At this stage, the gas bubbles are still isolated, demonstrated as individual localized strong reflectors in the plots and they are becoming larger. In the meantime, fluctuations of the capacity and efficiency of the battery can be observed in the graph of FIG. 6B. The battery performance degradation may be caused by the separation of the anode(s) and the cathode(s) by the gas bubbles, which reduces the ion transportation efficiency, increases the battery resistance and decreases the accessible capacity.

In FIG. 7J representing the 200th cycle, isolated gas bubbles are merged to form a giant gas channel, and the back surface features almost completely disappear. Similar phenomena have been observed in a previous study conducted by in-situ X-ray tomography imaging. By the 200th cycle, the intensity and number of reflectors have largely increased in the −6 dB threshold image, and a giant gas channel can be observed in FIG. 7M with a length of about 20 millimetres in this stage. Some individual gas bubbles that have not yet been merged can also be seen next to the gas channel.

The gas channels continue to expand laterally until they reach the edge of the cell, between the electrodes and aluminum plastic film. Gases will then float upward because of buoyancy, and eventually they accumulate on the top surface of the cell, forming a gassing gap that completely blocks the ultrasonic signal, as shown in FIG. 7K. In the 300th cycle shown in FIG. 7L, the top surface is filled with gas, and the ultrasonic signal can hardly penetrate. When the gases float up away from inside the cell, the capacity could be partially recovered, and the decay rate is slower than that before 200 cycles as shown in the graph of FIG. 6B. It can be attributed to the fact that most of the gases are now in the position between the electrode and aluminum plastic film, where there are no active materials.

Of note, the above experimental results are acquired under normal electrochemical conditions, and no swelling phenomena were observed. The battery is cycled at real room temperature, instead of abuse test conditions with overcharging or high temperatures. The imaging results indicate that when the electrochemical method has difficulties to detect and characterise gases, the ultrasonic method can confidently detect them, and even obtain the depth and size information of the gases from the subsurface cross-section images. The dynamic evolution of the gases along with the cycling can also be visualized and approximately quantified from images.

Ex-situ X-ray computed tomography (CT) imaging was carried out to validate gas generation and evolution in the LIB observed from ultrasonic array images. The CT images are taken at the initial state before cycling and the late stage after 300 cycles when giant floating gas layer are generated. The scan of the battery cell was performed using a high-resolution CT facility (FF35, YXLON from Comet Yxlon GmbH, Hamburg, Germany) under 220 kV, 100 μA and 22 W power. For each tomographic dataset, 3600 projections were obtained with an exposure time of 0.33 s per projection. The image resolution is with a voxel size of 13.9 μm. The raw X-ray projections were then reconstructed using Dragonfly software (ORS, Montreal, Canada) and imported into myVGL software (Volume Graphics, Germany) for further denoising, segmentation, visualization, and quantification.

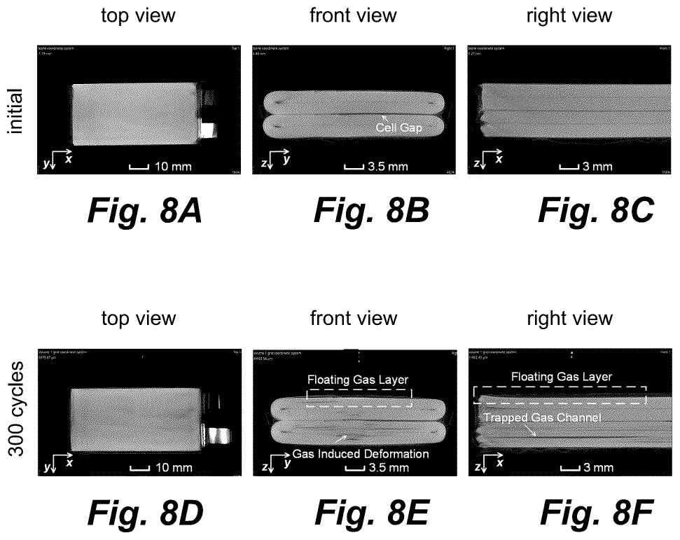

FIGS. 8A-8F show X-ray tomography verification. FIGS. 8A-8C are X-ray computer tomography (CT) images of a battery in an initial state in top, front and right views. FIGS. 8D-8F are X-ray CT images of a battery in an after-cycling state (i.e., after cycling) in top, front and right views.

The X-ray CT images in FIGS. 8A-8F are reconstructed images of the battery structure from both the top view and the side view. As shown in FIGS. 8B and 8C, the layer structure inside the cell is relatively flat and regular at the initial state. The only notable feature is the gap between two cells which is caused by winding. The gap is fulfilled with electrolyte at the initial state and the ultrasonic waves can pass through the interface, so it is not visible from ultrasonic TFM images in the first few cycles from FIG. 7A, 7B and 7C; however, the pressure inside the gap between the two cells is relatively smaller, so the gases generated in later cycles are more likely to accumulate in the gap. This may explain the observation from the ultrasonic images in FIGS. 7E-7I that strong gas reflectors are found around the middle of the whole battery.

Lastly, as shown in FIGS. 8E and 8F, a clear gas layer can be seen in the X-ray image between the Al-plastic film and the first battery layer. This observation is consistent with that from the ultrasonic array image shown in FIGS. 7J and 7K. From the X-ray CT images, there is no obvious lithium precipitation in the battery. This indicates that the main reasons for the changes in Coulombic efficiency and battery capacity described supra are the evolution of gas and the change in external temperature. The layer deformations and gas channels that are still trapped inside the cell can also be seen, which are consistent with the observations represented by FIGS. 7A-7L. It is noted that when the gases float and fill the top layer, ultrasonic waves are blocked so it is not readily possible to detect the internal gas channels below. One solution is to take measurement from the back surface as well to image the internal gases.

### Closing Statement

The ultrasonic phased array imaging technique may be used to detect and locate gases inside pouch cell batteries by producing subsurface cross-section images. A velocity-modified TFM technique is developed for imaging gas bubbles, which includes the effects of the anisotropic mechanical properties of the multi-layer battery structure. Gas locations and distributions in both the lateral and thickness directions (e.g., at which battery layer) can be clearly identified from the TFM images. The disclosed array imaging technique was first successfully validated in a controlled experiment to detect and locate pre-set encapsulated air gases in a stacked pouch cell. Experiments with commercial pouch cells were then performed, and the array imaging technique enables in-situ monitoring the dynamic evolution of gas bubbles generated within a LIB during cycling under a normal working condition. This capability was achieved thanks to the simple measurement setup and fast data acquisition speed. The ultrasonic array imaging can be applied to investigate gas generation mechanisms in a variety of batteries and to assist the development of new batteries with high capacity and energy density. Future work involves applying a two-dimensional phased array to realize 3D imaging reconstruction of gases inside a battery, and optimization of the array imaging parameters such as frequency and angles to achieve higher resolution and sensitivity in detecting smaller gas bubbles.

While testing of Lithium Ion Batteries (LIB) is described, the described techniques can be used to evaluate different battery types, including electrical batteries having different chemistries and including storage batteries and primary batteries.

It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for analyzing battery cell structure, the method comprising:
providing a subsurface ultrasonic phased array imaging system comprising multiple transmitter-receiver pairs to provide phased array tomography;
mapping and evaluating properties of the battery cell structure using the ultrasonic phased array imaging system; and
using the mapping to detect, locate and characterize gases and monitor evolution of the gases in the battery cell structure, by producing subsurface interior gas images at different cycles.

2. The method as described in claim 1, further comprising:
using the ultrasonic phased array imaging system for collecting ultrasonic signals scattered from internal anomalies to produce cross-sectional images that reveal locations, distributions and physical properties of the anomalies, accommodating both lateral and thickness variations of scanned portions of the battery cell structure.

3. The method as described in claim 2, further comprising:
detect, locate and characterize gases using the ultrasonic phased array imaging system and monitoring the gases evolution in a Lithium Ion Battery (LIB), by producing subsurface interior gas images at different cycles of battery operation.

4. The method as described in claim 1, further comprising:
cycling a battery as a unit under test while using ultrasonic phased array imaging system for said mapping and evaluation of properties.

5. The method as described in claim 4, further comprising:
obtaining the mapping and evaluation of properties by producing the subsurface cross-section interior gas images at different charging and discharging cycles of battery operation or following different numbers of charging and discharging cycles of battery operation.

6. The method as described in claim 1, further comprising:
cycling a battery as a unit under test while using ultrasonic phased array imaging system for said mapping and evaluation of properties; and
performing the cycling for a predetermined number of cycles of battery operation to provide evaluation of gas bubble evolution over the course of said predetermined number of cycles of battery operation.

7. The method as described in claim 1,
wherein the ultrasonic phased array imaging system for mapping and evaluation of properties provides a velocity-modified Total Focusing Method (TFM), wherein the TFM provides a capability of imaging gas bubbles, including determining effects of the anisotropic mechanical properties of the battery cell structure,
and wherein the TFM provides data to reveal anomalies in the battery cell structure, and locations and distributions in lateral and thickness directions of the anomalies.

8. The method as described in claim 1,
wherein the ultrasonic phased array imaging system for mapping and evaluation of properties provides a velocity-modified Total Focusing Method (TFM), wherein the TFM provides a capability of imaging gas bubbles, including determining effects of the anisotropic mechanical properties of the battery cell structure,
and wherein the TFM provides data concerning gas locations and distributions in lateral and thickness directions of the battery cell structure.

9. The method as described in claim 1,
wherein the ultrasonic phased array imaging system for mapping and evaluation of properties provides a velocity-modified Total Focusing Method (TFM), wherein the TFM provides a capability of imaging gas bubbles, including determining effects of the anisotropic mechanical properties of the battery cell structure as a multi-layer battery structure,
and wherein the TFM provides data concerning gas locations and distributions in lateral and thickness directions of the battery cell structure, including at which battery layer the gas locations occur.

10. The method as described in claim 1, further comprising:
applying thermal sensing to monitor battery temperature and changes in battery temperature during cycling.

11. Apparatus for analyzing battery cell structure, comprising:
a subsurface ultrasonic phased array imaging system comprising a phased array controller and multiple transmitter-receiver pairs driven by the phased array controller and capable of providing phased array tomography;
a processing unit controlling the phase array controller and receiving signals detected by the multiple transmitter-receiver pairs, the processing unit collecting data resulting from the phased array tomography;
a battery testing system capable of charging and discharging batteries or battery cells as units under test.
the ultrasonic phased array imaging system providing mapping and evaluation of properties of the batteries or battery cells as units under test, and providing an ability to detect, locate and characterize gases and monitor evolution of the gases in the battery cell structure, by producing subsurface interior gas images at different cycles.

12. The apparatus of claim 11, further comprising:
the ultrasonic phased array imaging system providing a capability of collecting ultrasonic signals scattered from internal anomalies producing cross-sectional images that reveal locations, distributions and physical properties of the anomalies, accommodating both lateral and thickness variations of scanned portions of the battery cell structure,
wherein the ultrasonic phased array imaging system provides a capability of detecting, locating and characterizing gases and monitor their evolution in a Lithium Ion Battery (LIB), by producing subsurface interior gas images at different cycles of battery operation.

13. The apparatus of claim 11, further comprising:
the battery testing system cycling a battery as a unit under test; and
the ultrasonic phased array imaging system providing said mapping and evaluation of properties after predetermined numbers of cycles of battery operation provides mapping and evaluation of properties of the batteries or battery cells as units under test during or after a predetermined number of cycles of battery operation.

14. The apparatus of claim 11,
wherein the ultrasonic phased array imaging system for mapping and evaluation of properties provides a velocity-modified Total Focusing Method (TFM), wherein the TFM provides a capability of imaging gas bubbles, including determining effects of the anisotropic mechanical properties of the battery cell structure,
and wherein the TFM provides data to reveal anomalies in the battery cell structure, and locations and distributions in lateral and thickness directions of the anomalies.

15. The apparatus of claim 11,
wherein the ultrasonic phased array imaging system for mapping and evaluation of properties provides a velocity-modified Total Focusing Method (TFM), wherein the TFM provides a capability of imaging gas bubbles, including determining effects of the anisotropic mechanical properties of the battery cell structure as a multi-layer battery structure,
and wherein the TFM provides data concerning gas locations and distributions in lateral and thickness directions of the battery cell structure, including at which battery layer the gas locations occur.

16. The apparatus of claim 11, further comprising:
a sensor capable of applying thermal sensing to monitor battery temperature and changes in battery temperature during cycling.
